(19) United States
(12) Patent Application Publication
(10) Pub. No.: US 2019/0391531 A1
(43) Pub. Date: Dec. 26, 2019

(54) HUMAN BODY SECURITY CHECK SYSTEM AND METHOD BASED ON MILLIMETER WAVE HOLOGRAPHIC THREE-DIMENSIONAL IMAGING

(71) Applicants: SHENZHEN INSTITUTE OF TERAHERTZ TECHNOLOGY AND INNOVATION, Shenzhen, Guangdong (CN); CHINA COMMUNICATION TECHNOLOGY CO., LTD., Shenzhen, Guangdong (CN)

(72) Inventors: Chunchao QI, Shenzhen (CN); Shukai ZHAO, Shenzhen (CN); Juncheng LIU, Shenzhen (CN); Guangsheng WU, Shenzhen (CN); Qing DING, Shenzhen (CN); Chengyan JIA, Shenzhen (CN); Beibei LIU, Shenzhen (CN); Yandong ZHANG, Shenzhen (CN); Yanli LIU, Shenzhen (CN)

(21) Appl. No.: 16/065,953

(22) PCT Filed: Jan. 27, 2016
(86) PCT No.: PCT/CN2016/072418

§ 371 Date: Jun. 25, 2018

(30) Foreign Application Priority Data
Dec. 25, 2015 (CN) 201510992149.7

(51) Int. Cl. G03H 1/00; G03H 1/04

(52) U.S. Cl. CPC G03H 1/0011; G01S 13/89; G03H 2001/0456; G03H 1/0443

(57) ABSTRACT

A human body security check system based on millimeter wave holographic three-dimensional imaging, comprising a mechanical scanning mechanism, millimeter wave signal transceiver units, an image processing unit (7), and an alarm unit (9). The mechanical scanning mechanism is used for driving the millimeter wave signal transceiver units to simultaneously move horizontally and vertically relative to an individual to be checked (10); the millimeter wave signal transceiver units are used for transmitting millimeter wave signals to the individual to be checked (10) and receiving millimeter wave signals reflected by the individual to be checked (10); the image processing unit (7) is used for performing holographic three-dimensional imaging on the body of the individual to be checked (10) according to the reflected millimeter wave signals so as to obtain a three-dimensional image of the body; the alarm unit (9) is used for comparing the three-dimensional image of the body with a three-dimensional image of a secure body pre-stored in the alarm unit (9), and giving an alarm if the three-dimensional image of the body does not match the three-dimensional image of the secure body pre-stored in the alarm unit. The human body security check system is low in costs because electrical scanning is replaced with mechanical scanning, and features a simple structure, a short production period, high resolution, a short imaging time, and wide application. Also provided is a human body security check method based on millimeter wave holographic three-dimensional imaging.

### TECHNICAL FIELD

Aspects of the present disclosure relate to a body security check system, and more particularly, to a system and a method for body security check based on millimeter wave holographic 3D imaging.

### Background

In recent years, security issues are gaining attention from people all around the world, and the demand for security check system's reliability and intelligence is higher. Conventional metal detectors can only detect objects in a close and small range, the efficiency is low, and thus is far from meeting security check requirement. Although rays, such as X ray, have strong penetrating power, they will cause radiation damage to the detected body. Even there are some X-ray machines of low radiation dose, they are not easy to be accepted by the public. Infrared imaging relies on the surface temperature of an object, and clear imaging cannot be accomplished in the condition of fabric covering. A millimeter wave imaging system can not only detect metal objects hidden under fabric, but also can detect hazardous articles such as a plastic pistol and explosive. Information obtained from the millimeter wave imaging system is more elaborate and accurate, which can greatly reduce false alarm rate. Therefore, millimeter wave imaging technology has been more widely used in body security check in recent years.

Millimeter wave imaging system usually has two working modes, active and passive. The basal principle of Passive Millimeter Wave (PMMW) imaging system is based on any object in natural world continuously radiating electromagnetic wave. This electromagnetic wave is constituted of uncorrelated waves of different frequencies, which are random and have broad frequency spectrum and different polarization directions. Different objects have different radiances at different wave bands. The passive millimeter wave imaging relies on atmospheric propagation window of millimeter waves with 35 GHz, 94 GHz, 140 GHz, and 220 GHz to receive the small difference of brightness temperatures between targets and the background, so as to differentiate different targets (Apple by. R., et al. IEEE Transactions on, 2007, 55(11): 2944-2956). The brightness temperature of the target mainly comprises three factors, i.e., radiation of the target itself, reflection of environmental noise, and transmission of environmental noise. Materials with higher relative dielectric constant or higher electric conductivity have smaller radiance and higher reflectance. In the same temperature, compared with material with lower conductivity, a material with higher conductivity has lower radiation temperature, i.e., cooler.

Generally, a passive millimeter wave imaging system comprises a receiving antenna, a millimeter wave radiometer, a scanning mechanism and a signal processing unit. The system's temperature resolution and spatial resolution are important parameters to measure imaging effect. Compared with outdoor imaging, indoor imaging needs higher temperature resolution.

In the mid-90s of last century, the first generation of millimeter wave radiometer imaging system has been studied in the United States. Early millimeter wave imaging systems commonly have the problems of long scanning time and poor sensitivity. Research institutes, having representative research results on passive millimeter wave focal plane array imaging system, have made different response solutions and products, for example, Millivision testing gate of the Millivision corporation. This system adopts a linear scanning structure, having four rows of receivers, 64 receivers in each row, the longitudinal separation of adjacent two rows is ¼ of the separation of two units in each row. The system has the field of view of 1.92 m×0.768 m at 1 meter, a resolution of 3 mm×3 mm, a pixel of 640×256. The imaging time of each image is 10 seconds (Huguenin G. Richard. SPIE, 1997, 2938: 152-159); the commercial real-time hidden weapon investigation camera of Brojot corporation; focal plane array (FPA) 3 min outdoor imaging system of TRW corporation integrated by 1040 W waveband receivers, and so on. Although passive millimeter wave imaging system has simple structure and low cost for implementing, its imaging time is too long and imaging resolution is low, so it cannot be practical and commercialized. As such, many research institutes pay more attention to the research of active millimeter wave imaging system.

At present, the best active millimeter wave imaging system is the rotational scanning 3D holographic millimeter wave imaging system of US L-3 corporation, and the research technology result comes from US Pacific Northwest National Laboratory (PNNL). This system arranges antennas in vertical direction and generates two images of body's front and back portions by the scanning mode of rotating 120 degrees in the horizontal direction (Douglas L. McMakin, et al. SPIE, 2007,6538: 1-12), and the image algorithm is according to performing holographic inversion calculation on obtained information to realize 3D holographic imaging. This technology has been authorized to L-3 communications and Save View corporations and has been commercially used in large airports, railway stations and international marinas in various developed countries. However, the two arrays of transceiving antennas of this system comprise 384 transceiving units in total, and each array comprises 192 transceiving units. Hence, the structure is complicated and the cost is very high.

Except US PNNL and other laboratories, university research institutes and corporations in different countries have gradually taken part in the research of millimeter wave imaging technology, and typical institutes and corporations are UK Reading University, German Microwave and Radar Institute, German Aerospace Center, Australia ICT center and Japan NEC corporation, etc. All these research institutes have reported research results about millimeter wave imaging. At home, units researching PMMW imaging system at present mainly comprise Center for Space Science and Applied Research of Chinese Academy and Sciences, national 863 Plan project microwave remote sensing technology laboratory, Nanjing University of Science and Technology, Huazhong University of Science and Technology, Southeast University, Harbin Institute of Technology, and so on. For example, the millimeter wave imaging technology research team in Nanjing University of Science and Technology has developed an elementary prototype of ka waveband alternating current radiometer scanning imaging (Zelong Xiao, research on millimeter wave radiation imaging used for body concealed objects[D], Nanjing: Nanjing University of Science and Technology, 2007); Research has been carried out for detecting hidden forbidden objects by W waveband direct current radiometer scanning imaging (Songsong Qian, research on key technology of passive millimeter wave array detection imaging[D], Nanjing: Nanjing University of Science and Technology, 2006); Huazhong University of Science and Technology has analyzed the radiation characteristic and imaging mechanism of 3mm waveband and the method of improving image resolution, has researched key technologies of millimeter wave radiation detection and recognition of metal objects and passive millimeter wave array detection imaging (Guangfeng Zhang, research on millimeter wave radiation characteristic and imaging[D], Wuhan, Huazhong University of Science and Technology, 2005); Wenbin Dou et al. in the millimeter wave key laboratory of Southeast University have researched on antenna-extended hemispherical medium lens for millimeter wave focal plane imaging and have established a millimeter wave imaging laboratory for concealed weapons (Wenbin DOU. IEICE Transactions on Electronics, 2005, E88(7): 1451-1456); Jinghui Qiu et al. in Harbin Institute of Technology have developed a prototype of ka waveband 20-channel millimeter wave focal plane array imaging system to realize indoor detection of body hidden objects, and so on.

In view of the above, existing millimeter wave body imaging systems have the following drawbacks: passive millimeter wave imaging systems have slow imaging speed and inferior resolution, and active millimeter wave imaging system has a great many transceiving units, complicated structure and high cost.

### SUMMARY

The objective of this invention is to solve the problems of slow imaging speed, inferior resolution, a great many transceiving units and complicated structure in current millimeter wave imaging based body security check system.

In order to solve the above problems, in one aspect, this invention provides a body security check system based on millimeter wave holographic 3D imaging, which comprises a mechanical scanning mechanism, a millimeter wave signal transceiving unit, and an image processing unit;

the mechanical scanning mechanism configured to drive the millimeter wave signal transceiving unit to move in the horizontal and vertical directions with respect to a person to be security checked at the same time;
the millimeter wave signal transceiving unit configured to transmit millimeters wave signals to the person to be security checked and receive millimeter wave signals reflected from the person to be security checked;
the image processing unit configured to perform holographic 3D imaging on the body of the person to be security checked according to the reflected millimeter wave signals to obtain the body's 3D image.

Further, an alarm unit is comprised. The alarm unit is configured to compare the body 3D image with a safe body 3D image prestored in the alarm unit, and if mismatching, the alarm unit raises the alarm.

Further, the millimeter wave signal transceiving unit comprises a millimeter wave signal transmitting unit and a millimeter wave signal receiving unit; the millimeter wave signal transmitting unit comprises a millimeter wave signal transmitting module and a transmitting antenna connected to the millimeter wave signal transmitting module, and the millimeter wave signal receiving unit comprises a millimeter wave signal receiving module and a receiving antenna connected to the millimeter wave signal receiving module;
the transmitting antenna and the receiving antenna are mounted on the mechanical scanning mechanism and are driven by the mechanical scanning mechanism to move relative to the person to be security checked.

Further, the mechanical scanning mechanism comprises a vertical scanning mechanism and a horizontal scanning mechanism;
the vertical scanning mechanism comprises vertical guideways and a vertical traction motor; two millimeter wave signal transceiving units opposite each other are mounted on the vertical guideways, and each millimeter wave signal transceiving unit is driven by the vertical traction motor to move up and down along corresponding vertical guideway; the horizontal scanning mechanism comprises a horizontal beam and a horizontal rotation motor, wherein both ends of the horizontal beam are fixedly connected to the top ends of the vertical guideways, and the horizontal beam and the vertical guideways are driven by the horizontal rotation motor to rotate in a horizontal plane.

Further, the millimeter wave signal transmitting unit comprises a first independent signal source, a linear frequency modulation source, a first mixer, a first wideband filter, a first frequency doubling link, and a transmitting antenna;
the output signal of the first independent signal source and the output signal of the linear frequency modulation source are sent to the input end of the first wideband filter after being mixed by the first mixer, the output end of the first wideband filter is connected to the input end of the first frequency doubling link, and the output end of the first frequency doubling link is connected to the transmitting antenna.

Further, the first frequency doubling link comprises a first power amplifier and a first frequency doubler, the output end of first wideband filter is connected to the input end of the first power amplifier, the output end of the first power amplifier is connected to the input end of the first frequency doubler, the output end of the first frequency doubler is connected to the transmitting antenna.

Further, the millimeter wave signal receiving unit comprises a second independent signal source, a second mixer, a second wideband filter, a second frequency doubling link, a third mixer, a receiving antenna, a fourth mixer, a fifth mixer, a third frequency doubling link, and a low noise amplifier;
the output signal of the second independent signal source and the output signal of the linear frequency modulation source are sent to the input end of the second wideband filter after being mixed by the second mixer, the output end of the second wideband filter is connected to the input end of the second frequency doubling link, the output end of the second frequency doubling link is connected to one input end of the third mixer, the other input end of the third mixer is connected to the receiving antenna; one input end of the fourth mixer is connected to the first independent signal source, the other input end of the fourth mixer is connected to the second independent signal source, the output end of the fourth mixer is connected to the input end of the third frequency doubling link, the output end of the third frequency doubling link is connected to one input end of the fifth mixer, and the other input end of the fifth mixer is connected to the output end of the third mixer, the output end of the fifth mixer is connected to the input end of the low noise amplifier, and the output end of the low noise amplifier is connected to the image processing unit.

Further, the second frequency doubling link comprises a second power amplifier and a second frequency doubler, the output end of the second wideband filter is connected to the input end of the second power amplifier, the output end of the second power amplifier is connected to the input end of the second frequency doubler, and the output end of the second frequency doubler is connected to the third mixer.

Further, the third frequency doubling link comprises a third power amplifier and a third frequency doubler, the output end of the fourth mixer is connected to the input end of the third power amplifier, and the output end of the third power amplifier is connected to the input end of the third frequency doubler, and the output end of the third frequency doubler is connected to the fifth mixer.

Further, the image processing unit comprises a low pass filter, a synclastic quadrature demodulator, a video filter, and a data acquisition storage processor connected in sequence.

Further, the sliding block slides from the ground of the detection room to the top.

Further, the horizontal beam and the vertical guideways rotate in a horizontal plane with a rotation angle of 0°-120°.

Further, the first independent signal source is a frequency modulation source with a working frequency of 20 GHz-23 GHz.

Further, the second independent signal source is a frequency modulation source with a working frequency of 19.95 GHz-22.95 GHz.

According to another aspect, this invention provides a body security check method based on millimeter wave holographic 3D imaging, comprising the following steps:
(1) a horizontal rotation motor drives a horizontal beam and vertical guideways to do uniform circular motion in a horizontal plane; meanwhile, a vertical traction motor drives transceiving antennas on the sliding blocks of vertical guideways to do uniform linear motion up and down in a vertical direction; a transmitting antenna in the transceiving antenna transmits a millimeter wave to the body of the person to be security checked in a cylindrical open detection room to scan the body on all aspects from up to down with the millimeter wave;
(2) meanwhile, a receiving antenna in the transceiving antenna receives an echo signal with object information reflected by the body, and the echo signal is sent to a high-speed data acquisition card of an image processing unit through a millimeter wave signal receiving module;
(3) after acquiring data, the high-speed data acquisition card of the image processing unit sends the acquired data to a data acquisition storage processor to restore the body image information from the received signal by holographic imaging algorithm;
(4) the above body image information is compared with a standard safe body 3D image prestored in an alarm unit to check whether it matches; and if it matches, then the person passes the security check;
(5) Security check is performed on the next person.

Further, in step (4), if it does not match, the alarm in the alarm unit raise an audible alarm, and the person to be security checked is manually detected to rule out security risk.

Further, the transmitting signal of the transmitting antenna is set as p(t), the radius of a circular trace generated by the vertical guideway's horizontal rotation is set as R, the vertical guideway's horizontal rotation angle is set as θ, the transceving antenna's displacement in vertical direction is set as Z, the sampling position is set as (R, θ, Z), the coordinate of any imaging position Pₙ in the body is set as (xₙ, yₙ, zₙ), and the corresponding scattering intensity is σ (xₙ, yₙ, zₙ), the echo signal received by the receiving antenna in the (t, θ, zₙ) domain is:

$${S}_{n} ( t , θ , z ) = σ ( {x}_{n} , {y}_{n} , {z}_{n} ) p ( t - \frac{2 \sqrt{\begin{matrix}{( {x}_{n} - R cos θ )}^{2} + {( {y}_{n} - R sin θ )}^{2} + \\ {( {Z}_{m} - {z}_{n} - Z )}^{2}\end{matrix}}}{c} ) ,$$

wherein
c is the velocity of light.
Further, the holographic imaging algorithm in step (3) comprises:
(a) performing Fourier transform on time t of the echo signal Sₙ (t, θ, z),

Sₙ(ω, θ, z)=P(ω)σ(xₙ, yₙ, zₙ) [symbol] exp(−j2k_{ω}{square root over ((xₙ−R cos θ)²+(yₙ−R sin θ)²+(Zₘ−zₙ−Z)²))}, set Zₘ−Z=z′, wherein k_{ω}=ω/c is the wave number, in the spatial wave number domain, the wave number components in each coordinate direction are kₓ, k_{y}, k_{z};

(b) neglecting signal amplitude's attenuation with distance and decomposing the spherical wave signal in the exponential term of step (a) into plane wave signals,

$${e}^{- j 2 {k}_{ω} \sqrt{{( R cos θ - x )}^{2} + {( R sin θ - y )}^{2} + {( {z}^{′} - z )}^{2}}} = \int \int {e}^{j ( 2 {k}_{r} cos φ ( R cos θ - x ) + 2 {k}_{r} sin φ ( R sin θ - y ) + {k}_{{z}^{′}} ( {z}^{′} - z ) )} d φ d {k}_{{z}^{′}} ,$$

the S(ω, θ, z)=∫∫e^{j2k}^{ᵣ}^{R cos(θ-φ)} [symbol] {∫∫∫σ(x, y, z)e^{-j2(k}^{ᵣ} ^{cos φ)x-j2(k}^{ᵣ}^{sin φ)y-jk}^{_{z′}}^{z}dxdydz} [symbol] e^{jk}^{_{z′}}^{z′}dφdk_{z′}; the 3D Fourier transform pair is defined as σ(x, y, z)⇔F_{σ(}2kᵣ cos φ, 2kᵣ sin φ, k_{z′}), S(ω, θ, z)=∫∫e^{j2k}^{ᵣ}^{R cos(θ-φ)} [symbol] ^{F}_{σ(}2Kᵣ cos φ, 2kᵣ sin φ, k_{z′})e^{jk}^{_{z′}}^{z′}dφdk_{z′}, performing Fourier transform on z of both sides of the equation S(ω, θ, z)=∫∫e^{j2k}^{ᵣ}^{R cos(ƒ-φ)} [symbol] F_{σ}(2kᵣ cos φ, 2kᵣ sinφ, k_{z′}, )e^{jk}^{_{z′}}^{z′}dφdk_{z′}, and neglecting the difference between z and z′, then S(ω, θ, k_{z})=∫_{-π/2}^{π/2}e^{j2k}^{ᵣ}^{R cos(θ-φ)} [symbol] F_{σ}(2kᵣ, φk_{z}) [symbol] F_{σ(}2kᵣ cos φ, 2kᵣ sin φ, k_{z}) and g(θ, kᵣ)≡e^{j2k}^{ᵣ}R cos θ, then S(ω, θ, k_{z})=g(θ, kᵣ) [symbol] F_{σ′}(2kᵣ, φ, k_{z}), performing Fourier transform on θ of the equation S(ω, θ, k_{z})=g(θ, kᵣ [symbol] F_{σ′}(2kᵣ, φ, k_{z}), and replacing ξ with θ, then

$${F}_{σ}^{\%} ( 2 {k}_{r} , ξ , {k}_{z} ) = \frac{S ( ω , ξ , {k}_{z} )}{G ( ξ , {k}_{r} )} ,$$

i.e., convolution is converted to product;

(c) performing inverse Fourier transform on the equation

$${F}_{σ}^{\%} ( 2 {k}_{r} , ξ , {k}_{z} ) = \frac{S ( ω , ξ , {k}_{z} )}{G ( ξ , {k}_{r} )}$$

of the step (b), then

$${F}_{σ} ( 2 {k}_{r} cos θ , 2 {k}_{r} sin θ , {k}_{z} ) = {F}_{( ξ )}^{- 1} [ \frac{S ( ω , ξ , {k}_{z} )}{G ( ξ , {k}_{r} )} ] ,$$

rewriting F_{σ}(2kᵣ cos θ, 2kᵣ sin θ, k_{z}) to obtain

$${F}_{σ} ( 2 {k}_{r} cos θ , 2 {k}_{r} sin θ , {k}_{z} ) = {F}_{ξ}^{- 1} [ S ( ω , ξ , {k}_{z} ) {e}^{- j \sqrt{4 {k}_{r}^{2} {R}^{2} - {ξ}^{2}}} ,$$

a phase factor e^{j√4k}^{^{r}}^{₂}^{R}^{₂}^{-ξ}^{₂} is introduced in this equation, a phase compensation is introduced here, and phase compensation plays an important role in short range scattering imaging, without phase compensation, a scattering echo distribution is broaden, so that an imaging result is blurring;

(d) performing an interpolation calculation from non-uniform sampling to uniform sampling in the spatial wave number domain (kₓ, k_{y}, k_{z}) to reconstruct target scattering intensity in a rectangular coordinate system;

(e) performing a final inverse 3D Fourier transform after the interpolation calculation to obtain the target scattering intensity in a rectangular coordinate system:

$$σ ( x , y , z ) = {F}_{( {k}_{x} , {k}_{y} , {k}_{z} )}^{- 1} \{ {F}_{ξ}^{- 1} [ S ( ω , ξ , {k}_{z} ) {e}^{- j \sqrt{4 {k}_{r}^{2} {R}^{2} - {ξ}^{2}}} ] \} .$$

Compared with existing millimeter wave imaging inspectors, this invention has the following notable advantages:

(1) Electrical scanning is replaced by mechanical scanning, so the price is low. This invention adopts a horizontal rotation motor to perform horizontal periphery 120° scanning and a vertical scanning motor to perform 2 meters vertical scanning in vertical direction. Therefore, only two symmetrical transceiving antennas are needed to accomplish body's omni-directional scanning, which reduce cost greatly.

(2) The structure is simple and the production cycle is short. The mechanical scanning mechanism in this invention adopts two motors and one guideway, which is very simple in structure, wherein the horizontal rotation motor drives the vertical guideway to rotate horizontally, and a vertical traction motor drive the two millimeter wave transceiving antennas to move up and down.

(3) The resolution is high. Because the transmitting signals in this invention are millimeter waves in the frequency band of 40 GHz-46 GHz, and the 3D holographic imaging algorithm is applied, the imaged planar resolution reaches 3.75 mm.

(4) The imaging is fast. In this invention, the signal transmitting and receiving time of the millimeter wave signal transceiving unit is controlled by adjusting the speed of the horizontal rotation motor and the vertical traction motor. The transceiving antenna in the vertical scanning guideway with length of 2 meters can accomplish body scanning once in about 1 second.

(5) The application is wide. The millimeter wave band in this invention can detect metal objects hidden under fabric, and can also detect hazardous articles such as plastic pistol and explosive. The obtained information is more elaborate and more accurate, which can reduce the false alarm rate significantly and thus is suitable for airplanes, customs, high-speed rail stations, exhibition centers, stadiums, and important military and political units.

### BRIEF DESCRIPTION OF THE ATTACHED DRAWINGS

FIG. 1 illustrates an over-all structural diagram according to an embodiment of this invention.

FIG. 2 illustrates a schematic diagram according to an embodiment of a millimeter wave signal transceiving unit and image processing unit of this invention.

FIG. 3 illustrates a working flow diagram according to this invention.

FIG. 4 illustrates a flow diagram of an imaging algorithm adopted by this invention.

FIG. 5 illustrates an imaging schematic diagram according to this invention.

In the drawings, horizontal rotation motor 1; vertical traction motor 2; horizontal beam 3; transceiving antenna 4; millimeter wave signal transmitting module 5; millimeter wave signal receiving module 6; image processing unit 7; detection room 8; alarm unit 9; person to be security checked 10; vertical guideway 11; first independent signal source 201, first mixer 202, first wideband filter 203; first power amplifier 204, first frequency doubler 205; transmitting antenna 206; linear frequency modulation source 207; second independent signal source 208, second mixer 209, second wideband filter 210; second power amplifier 211, second frequency doubler 212; third mixer 213; receiving antenna 214; fourth mixer 215; third power amplifier 216; third frequency doubler 217; fifth mixer 218; low noise amplifier 219; low pass filter 220; synclastic quadrature demodulator 221; video filter 222; data acquisition storage processor 223; first frequency doubling link 224; second frequency doubling link 225; third frequency doubling link 226.

### DETAILED DESCRIPTION

This invention is further described in detail in conjunction with appended drawings. Theses drawings are simplified schematic diagrams, illustrating the basic structures of this invention in a schematic way. Therefore, these drawings only show components related to this invention.

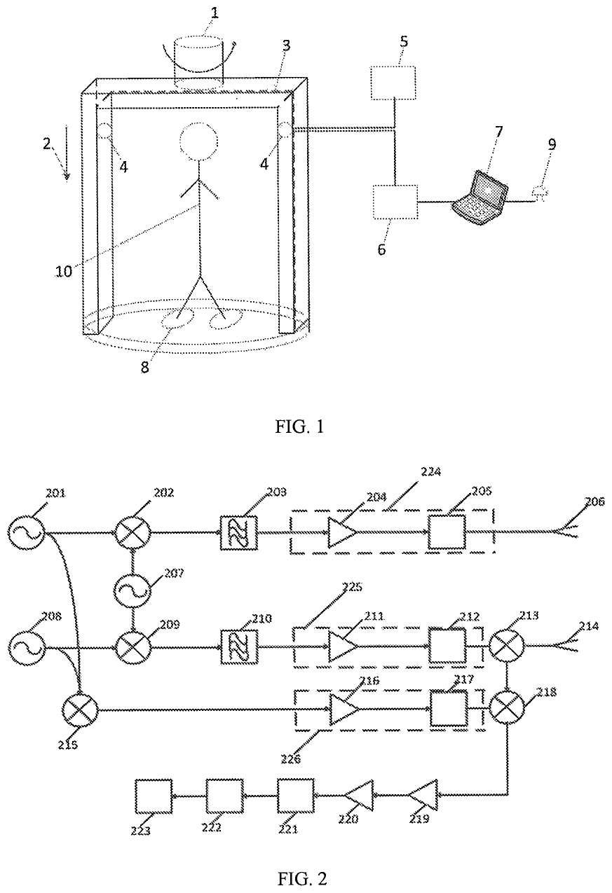

As illustrated in FIG. 1, the body security check system based on millimeter wave holographic 3D imaging proposed in this invention comprises a mechanical scanning mechanism, a millimeter wave signal transceiving unit, an image processing unit 7, and an alarm unit 9. The mechanical scanning mechanism comprises a horizontal rotation motor 1, a vertical traction motor 2, a horizontal beam 3, and vertical guideways 11, wherein the horizontal beam 3, the vertical guideways 11 and the ground form a space accommodating a person to be security checked. For convenience, the space formed by the horizontal beam 3, the vertical guideways 11 and the ground is referred to as a detection room 8. The millimeter wave signal transceiving unit comprises a transceiving antenna 4, a millimeter wave signal transmitting module 5 and a millimeter wave signal receiving module 6. As illustrated in FIG. 2, the transceiving antenna 4 comprises a transmitting antenna 206 and a receiving antenna 214. The millimeter wave signal transmitting module 5 is connected to the transmitting antenna 206, and the millimeter wave signal receiving module 6 is connected to the receiving antenna 214. The output signal of the millimeter wave signal receiving module 6 is transmitted to the image processing unit 7. The image processing unit 7 performs holographic 3D imaging on a person to be security checked according to this signal to obtain a body 3D image. The alarm unit 9 compares the body 3D image with a safe body 3D image prestored in the alarm unit 9. If mismatching, the alarm unit 9 will raise the alarm.

Two bilateral symmetry vertical guideways 11 are arranged on both sides of the detection room 8. Two ends of the horizontal beam 3 are respectively connected to the top ends of the two vertical guideways 11, so that the horizontal beam 3 and the two vertical guideways 11 constitute as a whole. The person to be security checked 10 stands on the ground of the detection room 8. In order that the guideway 11 can accommodate the millimeter wave signal transceiving units, a groove is arranged in the side of each vertical guideway 11 facing the person to be security checked 10 along the guideway from up and down, that is, one form of the guideway is groove. The groove extends from the ground of the detection room 8 to the top. The length of the groove (i.e., the guideway) is 2 meters. A sliding block is arranged in the groove, and the sliding block can slide up and down in the whole groove. There are a pair of transceiving antennas 4, which are respectively mounted on two sliding blocks. Here, setting the length of the groove (i.e., the guideway) to be 2 meters is to adapt to the height of the person to be detected, and the average person's height usually is 2 meter at most. The horizontal rotation motor 1 is connected to the horizontal beam 3, driving the horizontal beam 3 and the vertical guideways 11 to rotate in a horizontal plane with a rotation angle of 0°-120°. The vertical traction motor 2 is connected to the sliding block, driving the transceiving antennas 4 in the silding blocks to move up and down. The vertical move range in the groove of the vertical guideway 11 is 0-2 m from the ground of the detection room 8. As can be seen, the mechanical scanning mechanism does not scan the whole detected person completely. In other words, only the front and back of the detected person are detected. This is mainly because that a space for the detected person's passing in and out is reserved. Even though the detected person is not scanned completely, it is sufficient to get security check information.

FIG. 2 illustrates a schematic diagram of an embodiment of a millimeter wave signal transceiving unit and an image processing unit according to this invention. In this figure, the millimeter wave signal transmitting unit comprises a millimeter wave signal transmitting module 5 and a transmitting antenna 206. The millimeter wave signal transmitting module 5 comprises a first independent signal source 201, a first mixer 202, a first wideband filter 203, and a first frequency doubling link 224. The first frequency doubling link 224 comprises a first power amplifier 204 and a first frequency doubler 205. The millimeter wave signal receiving unit comprises a millimeter wave signal receiving module 6 and a receiving antenna 214. The millimeter wave signal receiving module 6 comprises a second independent signal source 208, a second mixer 209, a second wideband filter 210, a second frequency doubling link 225, a third mixer 213, a fourth mixer 215, a third frequency doubling link 226, a fifth mixer 218 and a low noise amplifier 219. The second frequency doubling link 225 comprises a second power amplifier 211 and a second frequency doubler 212. The third frequency doubling link 226 comprises a third power amplifier 216 and a third frequency doubler 217. The image processing unit 7 comprises a low pass filter 220, a synclastic quadrature demodulator 221, a video filter 222 and a data acquisition storage processor 223.

The first independent signal source 201 is a frequency modulation signal source with a working frequency of 20 GHz-23 GHz, and its output signal is input into the first mixer 202 to mix with a linear frequency modulation source 207. The signal after mixing is input into the first power amplifier 204 through the first wideband filter 203, so that the power of this link reaches a safe input power range of the first frequency doubler 205. After the first frequency doubler 205, the input frequency of this link is doubled to 40 GHz-46 GHz, and finally is radiated by the transmitting antenna 206. The second independent signal source 208 is a frequency modulation signal source with a working frequency of 19.95 GHz-22.95 GHz, and its output signal is input into the second mixer 209 to mix with the linear frequency modulation source 207.

The fourth mixer 215 mixes the signals from the first independent signal source 201 and the second independent signal source 208, and the difference frequency of 0.05 GHz is input to the third power amplifier 216, so that the power of this link reaches a safe input power range of the third frequency doubler 217. After the third frequency doubler 217, the frequency is doubled to 0.1 GHz and filially input into the fifth mixer 218.

The third mixer 213 is a three-port device, and the three ports are respectively radio frequency (RF) port, local oscillation (LO) port and intermediate frequency (IF) port, wherein the LO port receives the signal output from the second frequency doubler 212, the RF port is input a reflected echo signal received by the receiving antenna 214, and the IF port outputs a superheterodyne signal of the LO port and the RF port. This signal has a certain spatial object information, which is input into the radio frequency (RF) port of the fifth mixer 218.

The RF port of the fifth mixer 218 is input a first down-converted signal with object information output from the third mixer 213, the LO port is input a dot frequency signal of 0.1 GHz output from the third frequency doubler 217, and the IF port outputs a second down-converted signal with object information.

The low noise amplifier 219 can amplify the weak intermediate frequency signal after two down-conversions to improve the signal to noise ratio of the output signal. Signal output from the low noise amplifier 219 is input into the image processing unit 7.

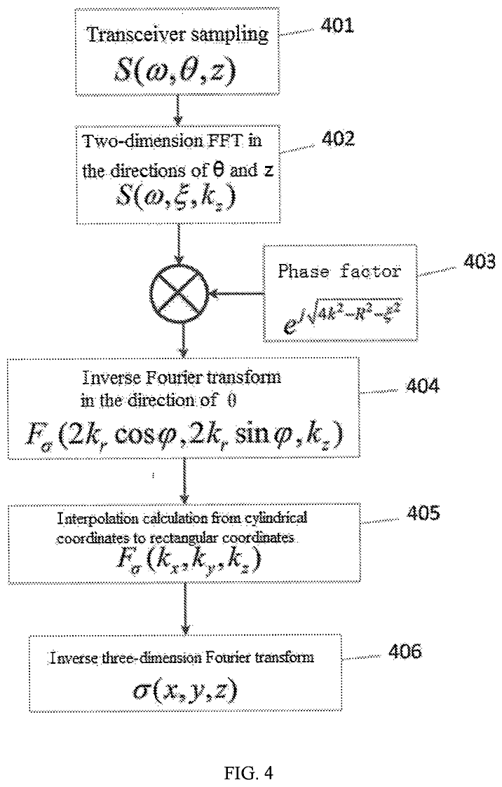

The image processing unit 7 comprises a high-speed data acquisition card that comprises the low pass filter 220, the synclastic quadrature demodulator 221 and the video filter 222, and the data acquisition storage processor 223 that performs image processing by holographic imaging algorithm. The data acquisition storage processor 223 may be a general-purpose computer. As illustrated in FIG. 4, the high-speed data acquisition card acquires the amplified and filtered echo signal (step 410) and inputs the signal into a computer in the form of mat file format. Then MATLAB is used to perform a Fourier transform from space domain to frequency domain through a 3D holographic imaging algorithm (step 402). After a series of simplifications and combinations (step 403), finally an inverse Fourier transform from frequency domain to space domain is performed (steps 404-406). The object 3D image is finally restored by performing the Fourier transform from space domain to frequency domain and inverse Fourier transform from frequency domain to space domain on the space domain object depth and size corresponding to the amplitude and phase information of the acquired signal.

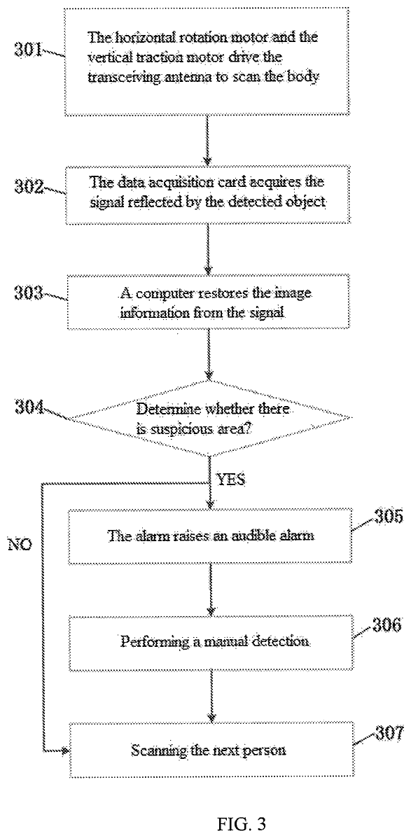

As illustrated in FIG. 3, when the system of this invention is applied to a person for security check, the person to be security checked 10 stands on the ground of the detection room 8, and following steps are comprised.

Step 301: the horizontal rotation motor 1 drives the horizontal beam 3 and the vertical guideways 11 to do uniform circular motion from 0° to 120° in a horizontal plane. Meanwhile, the vertical traction motor 2 drives the transceiving antenna 4 on the sliding block to do uniform linear motion up and down in a vertical direction from 0 to 2 meters. The transmitting antenna 206 in the transceiving antenna 4 transmits a millimeter wave to the body of the person to be security checked 10 in the cylindrical open detection room 8 to do omni-directional millimeter wave scanning from up to down.

According to the distribution of people's height in various countries in the world, the length L_{T} of the vertical guideway 11 is set to 2 m, the circle diameter R of the cylindrical open detection room 8 is set to 1.8 m, the one-time up and down scanning time is t, the total scanning time is t′, the velocity of the vertical traction motor 2 is V_{T}, and the velocity of the horizontal rotation motor 1 is ω. The velocity of the two motors can be controlled by presetting.

the velocity of the vertical traction motor

$${v}_{T} = \frac{{L}_{T}}{t} \qquad ( 1 )$$

the velocity of the horizontal rotation motor

$$ω = \frac{{120}^{°}}{{180}^{°}} π g \frac{1}{{t}^{′}} \qquad ( 2 )$$

When the person to be security checked 10 stands in the detection room 8, the horizontal rotation motor 1 and the vertical traction motor 2 start to work at the same time. While the horizontal rotation motor 1 drives the transceiving antenna 4 to do circular motion, the vertical traction motor 2 drives the transceiving antenna 4 to move up and down quickly, scanning the reflection information of multiple positions of the person during the multiple up and down motions and horizontal motions. In an embodiment, while the horizontal rotation motor 1 does 120° uniform circular motion, the vertical traction motor 2 drives the transceiving antenna 4 to uniformly move 2 meters from the top of the vertical guideway 11 down to the bottom of the guideway 11, and a one-time full-body scanning is completed. After this scanning is completed, the vertical traction motor 2 costs 0.5 seconds to quickly move back to the top of the vertical guideway 11 at the velocity of 4 m/s from down to up to continue a next body's scanning.

Step 302: Meanwhile, the receiving antenna 214 in the transceiving antenna 4 receives a body-reflecting signal with object information. The signal is sent to the high-speed data acquisition card of the image processing unit 7 through the millimeter wave signal receiving module 6.

Step 303: After acquiring data, the high-speed data acquisition card of the image processing unit 7 sends the acquired data to the data acquisition storage processor 223, e.g., a computer, to restore the body image information from the received signal by holographic imaging algorithm.

Step 304: The above body image information is compared with a standard safe body 3D image prestored in the alarm unit 9 to check whether it matches. If it matches, that is, there is no suspicious area in the body image information, the person to be security checked 10 is regarded as safe, and then turn to step 307. If it does not match, that is, there is suspicious area in the body image information, then proceed to the next step.

Step 305: The alarm in the alarm unit raises an audible alarm.

Step 306: The person to be security checked 10 is manually detected to rule out security risk.

Step 307: The next person is checked.

The cycle continues.

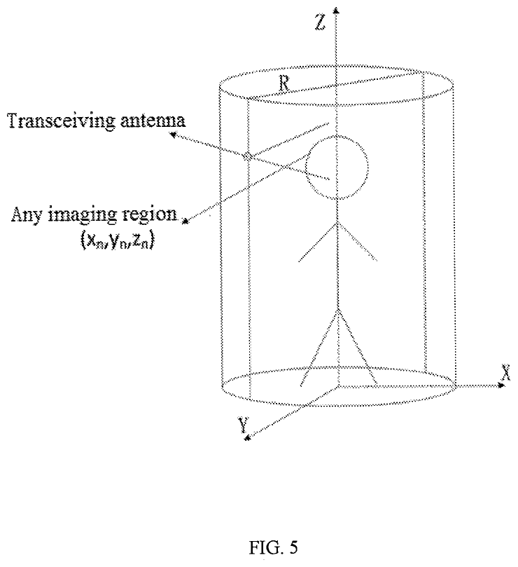

As illustrated in FIG. 5, the person is supposed at the center point O of a rectangular coordinate system. The axis of this person coincides with Z axis. The body's imaging area is a cylinder of (xₒ, yₒ, zₒ)=(Rₒ cos, Rₒ sin, Zₒ), wherein R₀ is the radius of the imaging area, ranging from 0 to 2Tr. In this figure, the guideway length is L_{T}, i.e., the synthetic aperture length along Z axis is L_{T}, and the aperture center locates at the plane of z=Zₘ. Driven by the horizontal motor, the vertical guideway rotates about the axis of the person in a circle with radius R, forming a synthetic aperture in the circle θ direction. (R, θ, Z) is defined as the sampling location. Any imaging location Pₙ on the body is defined as (xₙ, yₙ, zₙ), and the corresponding scattering intensity is σ(xₙ, yₙ, zₙ).

The antenna transmitting signal is defined as p(t), the echo signal detected by the receiving antenna in the (t, θ, z) domain is:

$${S}_{n} ( t , θ , z ) = σ ( {x}_{n} , {y}_{n} , {z}_{n} ) p ( t - \frac{2 \sqrt{\begin{matrix}{( {x}_{n} - R cos θ )}^{2} + {( {y}_{n} - R sin θ )}^{2} + \\ {( {Z}_{m} - {z}_{n} - Z )}^{2}\end{matrix}}}{c} ) \qquad ( 3 )$$

after being Fourier transformed on time t:

Sₙ(ω, θ, z)=P(ω)σ(xₙ, yₙ, zₙ) [symbol] exp (−j2k_{ω}{square root over ((xₙ−R cos θ)²+(yₙ−R sin θ)²+(Zₘ−zₙ−Z)²))} (4)

wherein wave number k_{ω}=ω/c. In actual situations, the object echo signal is the accumulation of object echo signals of multiple points in the imaging area. The signal amplitude's attenuation with distance is negligible, so set P(ω)=1.

The spherical wave signal in the exponential term can be decomposed into plane wave signals, and set Zₘ−Z=z′, then

$${e}^{- j 2 {k}_{ω} \sqrt{{( R cos θ - x )}^{2} + {( R sin θ - y )}^{2} + {( {z}^{′} - z )}^{2}}} = \int \int {e}^{j ( 2 {k}_{r} cos ϕ ( R cos θ - x ) + 2 {k}_{r} sin ϕ ( R sin θ - y ) + {k}_{{z}^{′}} ( {z}^{′} - z ) )} d ϕ d {k}_{{z}^{′}} \qquad ( 5 )$$

The decomposition of spherical wave signal can be regarded as the accumulation of plane wave signals transmitted by the object at (x, y, z). The dispersion relation of components of plane wave signal is kₓ²+k_{y}²+k_{z′}²=(2k_{ω)}², wherein kₓ, k_{y}, and k_{z} are the wave number components of k_{ω} along the coordinate axises in spatial wave number domain. In the X-Y plane, the wave number components of kᵣ are defined as

$${k}_{r} = \sqrt{{k}_{x}^{2} + {k}_{y}^{2}} = \sqrt{4 {k}_{ω}^{2} - {k}_{{z}^{′}}^{2}} .$$

The spherical wave signal decomposition (5) is substituted into the equation (2) for simplification, the echo signal can be expressed as

S(ω, θ, z)=∫∫e^{j2k}^{ᵣ}^{R cos(θ-φ)} [symbol] {∫∫∫σ(x, y, z)e^{-j2(k}^{ᵣ} ^{sinφ)x-j2(k}^{ᵣ}^{sin φ)y-jk}^{_{z′}}^{z}dxdydz} [symbol] [symbol] [symbol] (6)

The expression in { } of this equation is a 3D Fourier transform of the nonuniform sampling target scattering function. The 3D Fourier transform pair is defined as σ(x, y, z)⇔F_{σ}(2kᵣcos φ, 2kᵣ sinφ, k_{z′}), then equation (6) can be rewritten as S(ω, θ, z)=∫∫e^{j2k}^{ᵣ}^{R cos(θ-φ)} [symbol] F_{σ}(2kᵣ cos φ, 2kᵣ sin φ,k_{z′})e^{jk}^{_{z′}}^{z′}dφdk_{z′}.

after being Fourier transformed on z in both sides of this equation:

S(ω, θ, z)=∫_{-π/2}^{π/2}e^{j2k}^{ᵣ}R cos(θ−φ) [symbol] F_{σ}(2kᵣ cos φ, 2kᵣ sin φ, k_{z})dφ (7)

set F_{σ′}(2kᵣ, φ, k_{z})≡F_{σ}(2kᵣ cos φ, 2kᵣ sin φ, k_{z}) (8) and

g(θ, kᵣ)=e^{j2k}^{ᵣ}^{R cos θ} (9)

then S(ω, θ, k_{z})=g(θ, kᵣ) [symbol] F_{σ′}(2kᵣ, φ, k_{z}) (10)

θ in equation (10) is Fourier transformed, and θ is replaced by ξ, then convolution is converted to product:

$${F}_{σ}^{\%} ( 2 {k}_{r} , ξ , {k}_{z} ) = \frac{S ( ω , ξ , {k}_{z} )}{G ( ξ , {k}_{r} )} \qquad ( 11 )$$

Equation (11) is inverse Fourier transformed to obtain:

$${F}_{σ} ( 2 {k}_{r} cos θ , 2 {k}_{r} sin θ , {k}_{z} ) = {F}_{( ξ )}^{- 1} [ \frac{S ( ω , ξ , {k}_{z} )}{G ( ξ , {k}_{r} )} ] \qquad ( 12 )$$

The denominator of equation (12) can be numerically calculated by fast Fourier transform on data obtained by sampled equation (9) in the direction of angle θ, wherein 2kᵣ cos θ=kₓ, 2kᵣ sin θ=k_{y}. The sampled data in spatial wave number domain is non-uniformly distributed. Therefore, before calculating the final inverse 3D Fourier transform to obtain the target scattering intensity in a plane rectangular coordinate system, an interpolation calculation from non-uniform sampling to uniform sampling is performed in the spatial wave number domain (kₓ,k_{y},k_{z}). As such, the reconstructed target scattering intensity in a rectangular coordinate system is:

$$σ ( x , y , z ) = {F}_{( {k}_{x} , {k}_{y} , {k}_{z} )}^{- 1} \{ {F}_{ξ}^{- 1} [ S ( ω , ξ , {k}_{z} ) {e}^{- j \sqrt{4 {k}_{r}^{2} {R}^{2} - {ξ}^{2}}} ] \} \qquad ( 13 )$$

According to the above derivation procedure, an object's scattering intensity σ(x, y, z) can be obtained from the echo data S(ω, θ, z), and a millimeter wave holographic 3D imaging is realized finally.

In light of the above ideal embodiments according to this invention and according to the above description, persons skilled in the art can make various alternatives or modifications without departing from the spirit of this invention. The technical scope of this invention is not limited to the contents described in the specification, but should be determined by the scope of the claims.

1. A body security check system based on millimeter wave holographic 3D imaging, comprising: a mechanical scanning device;
a millimeter wave signal transceiving device; and
an image processing device,
wherein the mechanical scanning device is configured to move the millimeter wave signal transceiving device in horizontal and vertical directions relative to a person being security checked,
wherein the millimeter wave signal transceiving device is configured to transmit millimeter wave signals to the person being security checked and to receive millimeter wave signals reflected from the person being security checked, and
wherein the image processing device is configured to perform holographic 3D imaging of the body of the person being security checked based on the reflected millimeter wave signals to generate a 3D image of the person's body.

2. The body security check system of claim 1, further comprising an alarm device that is configured to compare the 3D image with a safe body 3D image stored in the alarm device; to generate an when a mismatch is found between the 3D image and the safe body 3D image.

3. The body security check system of claim 1, wherein the millimeter wave signal transceiving device comprises:
a millimeter wave signal transmitting device comprising:
a millimeter wave signal transmitting controller; and
a transmitting antenna connected to the millimeter wave signal transmitting controller;
a millimeter wave signal receiving device comprising:
a millimeter wave receiving controller; and
a receiving antenna connected to the millimeter wave receiving controller,
wherein the transmitting antenna and the receiving antenna are mounted on the mechanical scanning device and are moved, by the mechanical scanning device, relative to the person being security checked.

4. The body security check system of claim 3, wherein the mechanical scanning device comprises:
a vertical scanning device comprising:
a first vertical guideway having a first millimeter wave signal transceiving device mounted thereon;
a second vertical guideway having a second millimeter wave signal transceiving device mounted thereon with the second millimeter wave signal transceiving device mounted opposite to the first millimeter wave signal transceiving device; and
a vertical traction motor that is configured to move the first and second millimeter wave signal transceiving devices up and down along respective first and second vertical guideways; and
a horizontal scanning mechanism device comprising:
a horizontal beam having first and second ends that are fixedly connected to respective first and second top ends of the first and second vertical guideways; and
a horizontal rotation motor that is configured to move the horizontal beam and the first and second vertical guideways in a horizontal plane.

5. The body security check system of claim 4, wherein the millimeter wave signal transmitting device further comprises:
a first independent signal source that generates a first signal;
a linear frequency modulation source that generates a second signal;
a first mixer that receives and mixes the first and second signals to generate a third signal;
a first wideband filter that receives the third signal and generates a fourth signal;
a first frequency doubling link that receives the fourth signal and generates a fifth signal; and
a transmitting antenna that receives and transmits the fifth signal.

6. The body security check system of claim 5, wherein the first frequency doubling link comprises:
an input connection;
an output connection that is connected to the transmitting antenna, and
a first power amplifier comprising:
an input connection that is connected to an output connection of the first wideband filter, and
an output connection that is connected to the input connection of the first frequency doubling link.

7. The body security check system of claim 5, wherein the millimeter wave signal receiving device further comprises:
a second independent signal source that generates a sixth signal;
a second mixer that receives and mixes the second signal from the linear frequency modulation source and the sixth signal from the second independent signal source to generate a seventh signal;
a second wideband filter that receives the seventh signal and generates an eighth signal;
a second frequency doubling link that receives the eighth signal and generates a ninth signal;
a receiving antenna that receives and generates a tenth signal;
a third mixer that receives and mixes the ninth signal from the frequency doubling link and the tenth signal from the receiving antenna to generate an eleventh signal;
a fourth mixer that receives and mixes the first signal from first independent signal source and the sixth signal from the second independent signal source and generates a twelfth signal;
a third frequency doubling link that receives the twelfth signal and generates a thirteenth signal;
a fifth mixer that receives and mixes the eleventh signal from the third mixer and the thirteenth signal from the third frequency doubling link to generate a fourteenth signal; and
a low noise amplifier that receives the fourteenth signal and generates a fifteenth signal that is provided to the image processing device.

8. The body security check system of claim 7, wherein the second frequency doubling link comprises:
a second power amplifier; and
a second frequency doubling device,
wherein an output connection of the second wideband filter is connected an input connection of the second power amplifier,
wherein an output connection of the second power amplifier is connected to an input connection of the second frequency doubling device, and
wherein an output connection of the second frequency doubling device is connected to an input connection of the third mixer.

9. The body security check system of claim 7, wherein the third frequency doubling link further comprises:
a third power amplifier; and
a third frequency doubling link,
wherein an output connection of the fourth mixer is connected to the input connection of the third power amplifier,
wherein an output connection of the third power amplifier is connected to an input connection of the third frequency doubling link, and
wherein an output connection of the third frequency doubling link is connected to the fifth mixer.

10. The body security check system of claim 1, wherein the image processing device comprises the following devices connected in sequence:
a low pass filter;
a synclastic quadrature demodulator;
a video filter; and
a data acquisition storage processor.

11. The body security check system of claim 5, wherein the first independent signal source is a frequency modulation source with a working frequency in a range of about 20 GHz to about 23 GHz.

12. The body security check system of claim 7, wherein the second independent signal source is a frequency modulation source with a working frequency range of about 19.95 GHz to 22.95 GHz

13. A body security check method based on millimeter wave holographic 3D imaging, the method comprising:
driving, using a horizontal rotation motor, a horizontal beam and vertical guidewavs to perform uniform circular motion in a horizontal plane;
driving, using a vertical traction motor, transceiving antennas on sliding blocks of the vertical guidewavs to perform uniform linear motion up and down in a vertical direction;
transmitting, using a transmitting antenna in the transceiving antenna, a millimeter wave to the body of the person being security checked;
receiving, using a the transceiving antenna, an echo signal with object information reflected by the body;
sending, using an image processing device, the echo signal to a high-speed data acquisition card through a millimeter wave signal receiving module;
acquiring data by the high-speed data acquisition card of the image processing device;
sending, by the high-speed data acquisition card of the image processing device, the acquired data to a data acquisition storage processor;
performing, by the data acquisition storage processor, a holographic imaging algorithm to generate, body image information from the received signal using;
comparing the generated body image information with a standard safe body 3D image that was previously stored in an alarm device to determine whether the generated body image information matches the standard safe body 3D image; and
determining that the person passes the security check when the generated body image information matches the standard safe body 3D image.

14. The body security check method of claim 13, further comprising:
generating, by an alarm device, an audible alarm when the generated body image information fails to match the standard safe body 3D image

15. The body security check method of claim 13, further comprising:
establishing:
antenna is set as p(t),
the radius of a circular trace generated by the vertical guideway's horizontal rotation is set as R,
the vertical guideway's horizontal rotation angle is set as θ,
the transceving antenna's displacement in vertical direction is set as Z,
the sampling position is set as (R, θ, Z),
the coordinate of any imaging position P in the body is set as (xₙ, yₙ, zₙ), and
the corresponding scattering intensity is σ(xₙ, yₙ, zₙ), the echo signal received by the receiving antenna in the (t, θ, zₙ) domain is:
$${S}_{n} ( t , θ , z ) = σ ( {x}_{n} , {y}_{n} , {z}_{n} ) p ( t - \frac{2 \sqrt{{( {x}_{n} - R cos θ )}^{2} + {( {y}_{n} - R sin θ )}^{2} + {( {z}_{m} - {z}_{n} - Z )}^{2}}}{c} ) ,$$
wherein c is the velocity of light;
the holographic imaging algorithm in step (3) comprises:
(a) performing Fourier transform on time t of the echo signal Sₙ (t, θ, z), Sₙ (ω, θ, z)=P(ω)σ(xₙ, yₙ, zₙ) [symbol] exp(−j2k_{ω}{square root over ((xₙ−R cos θ)²+(yₙ−R sin θ)²+(Zₘ−zₙ−Z)²))}, set Zₘ−Z=z′, wherein k_{ω}=ω/c is the wave number, the wave number components in each coordinate direction are kₓ, k_{y}, k_{z};
(b) neglecting signal amplitude's attenuation with distance and decomposing the spherical wave signal in the exponential term of step (a) into plane wave signals,
$${e}^{- j 2 {k}_{ω} \sqrt{{( R cos θ - x )}^{2} + {( R sin θ - y )}^{2} + {( {z}^{′} - z )}^{2}}} = \int \int {e}^{j ( 2 {k}_{r} cos φ ( R cos θ - x ) + 2 {k}_{r} sin φ ( R sin θ - y ) + {k}_{{z}^{′}} ( {z}^{′} - z ) )} d φ d {k}_{{z}^{′}} ,$$
then
S(ω, θ, z)=∫∫e^{j2k}^{ᵣ}^{R cos(θ-φ)} [symbol] {∫∫∫σ(z, y, z)e^{-k2(k}^{ᵣ} ^{cos φ)x-j2(k}^{ᵣ} ^{sin φ)y-jk}^{_{z′}}^{z}dxdydz} [symbol] e^{jk}^{_{z′}}^{z′}dφdk_{z′}
; the 3D Fourier transform pair is defined as σ (x, y, z) [symbol] F_{σ}(2kᵣ cos φ, 2kᵣ sin φ, k_{z′}), then S(ω, θ, z)=∫∫e^{j2k}^{ᵣ}^{R cos(θ-φ)} [symbol] F_{σ}(2kᵣ cos φ, 2kᵣ sin φ,k_{z′})e^{jk}^{_{z′}}^{z′}dφdk_{z′}, performing Fourier transform on z of both sides of the equation
S(ω, θ, z)=∫∫e^{j2k}^{ᵣ} ^{R cos(θ-φ)} [symbol] F_{σ}(2kᵣ cos φ, 2kᵣ sin φ, k_{z′})e^{jk}^{_{z′}}^{z′}dφdk_{z′}, and neglecting the difference between z and z′, then
S(ω, θ, k_{z})=∫_{-π2}^{π/2}e^{j2k}^{ᵣ}R cos(θ−φ) [symbol] F_{σ}(2kᵣ cos φ, 2kᵣ sin φ, k_{z})dφ,
set F_{σ′}(2kᵣ, φ, k₂) [symbol] F_{σ}(2kᵣ cos φ, 2kᵣ sin φ, k_{z}) and set F^{,} (2kᵣ, pp, k_{z}) =F,(21(ᵣcos φ, 2kᵣsin φ, k _{z}) and
g(θ, kᵣ)≡e^{j2k}^{ᵣ}^{R cos θ}, then S(ω, θ, k_{z})=g(θ, kᵣ) [symbol] F_{σ′}(2kᵣ, φ,k_{z}), performing Fourier transform on θ of the equation S(ω, θ, k_{z})=g(θ, kᵣ) [symbol] to F_{σ′}(2kᵣ, φ, k_{z}), and replacing ξ with θ, then
$${F}_{σ}^{\%} ( 2 {k}_{r} , ξ , {k}_{z} ) = \frac{S ( ω , ξ , {k}_{z} )}{G ( ξ , {k}_{r} )} ,$$
i.e., convolution is converted to product;
(c) performing inverse Fourier transform on the equation
$${F}_{σ}^{\%} ( 2 {k}_{r} , ξ , {k}_{z} ) = \frac{S ( ω , ξ , {k}_{z} )}{G ( ξ , {k}_{r} )}$$
of the step (b), then
$${F}_{σ} ( 2 {k}_{r} cos θ , 2 {k}_{r} sin θ , {k}_{z} ) = {F}_{( ξ )}^{- 1} [ \frac{S ( ω , ξ , {k}_{z} )}{G ( ξ , {k}_{r} )} ] ,$$
rewriting F_{σ′}(2kᵣ cos θ, 2kᵣ sin θ, k_{z}) to obtain
$${F}_{σ} ( 2 {k}_{r} cos θ , 2 {k}_{r} sin θ , {k}_{z} ) = {F}_{ξ}^{- 1} [ S ( ω , ξ , {k}_{z} ) ] {e}^{- j \sqrt{4 {k}_{r}^{2} {R}^{2} - {ξ}^{2}}} ;$$
(d) performing an interpolation calculation from non-uniform sampling to uniform sampling in the spatial wave number domain (kₓ, k_{y}, k_{z}) to reconstruct target scattering intensity in a rectangular coordinate system;
(e) performing a final inverse 3D Fourier transform after the interpolation calculation to obtain the target scattering intensity in a rectangular coordinate system:
$$σ ( x , y , z ) = {F}_{( {k}_{x} , {k}_{y} , {k}_{z} )}^{- 1} \{ {F}_{ξ}^{- 1} [ S ( ω , ξ , {k}_{z} ) {e}^{- j \sqrt{4 {k}_{r}^{2} {R}^{z} - {ξ}^{2}}} ] \} .$$
